(19) United States
(12) Patent Application Publication
(10) Pub. No.: US 2006/0180073 A1
(43) Pub. Date: Aug. 17, 2006

(54) Whistle and whistle notification device

(75) Inventor: Kenji Nakamoto, Yokosuka-shi (JP)

Correspondence Address: STEVENS, DAVIS, MILLER & MOSHER, LLP, 1615 L. STREET N.W., SUITE 850, WASHINGTON, DC, 20036, US

(73) Assignee: Matsushita Electric Industrial CO., LTD., Kodoma-shi (JP)

(21) Appl. No.: 10/542,610

(22) PCT Filed: Jan. 20, 2004
(86) PCT No.: PCT/JP04/00396

§ 371 Date: Jul. 18, 2005

(30) Foreign Application Priority Data
Jan. 21, 2003 (JP) 2003-11998

(51) Int. Cl. G01N 31/22

(52) U.S. Cl. 116/200

(57) ABSTRACT

A whistle 1 generates and transmits whistle information when the whistle is blown, and a lamp apparatus 2 receives a radio signal transmitted from whistle 1, demodulates whistle information, and performs illumination of a lamp in accordance with the intensity of the sound of the whistle based on the whistle information. Thus, the fact that the whistle has been blown, and the strength with which it has been blown, can be ascertained visually. By this means, a whistle can be provided that enables a hearing-impaired person to recognize that the whistle has been blown, and to concentrate on playing without anxiety.

### TECHNICAL FIELD

The present invention relates to a whistle used as a signal in sports and so forth, and a whistle signaling apparatus.

### BACKGROUND ART

A whistle has traditionally been used as a signal for the start and end of a game, and rule infringements, in various kinds of sports such as volleyball, rugby, and soccer. A conventional whistle is known that is composed of a mouthpiece, a resonant chamber containing a rolling element made of cork or the like, and an airflow aperture.

However, with a conventional whistle, the fact that the whistle has been blown is conveyed to players via the sense of hearing, and there is a problem of unsuitability for sports played by hearing-impaired persons, for example.

That is to say, since it is impossible or difficult for a hearing-impaired person to hear the sound of a whistle, the player may continue to play without hearing the whistle, resulting in contact with another player which may be regarded as dangerous play. There are also many cases in which loss of playing time is caused by play being continued despite the whistle being blown. Furthermore, since a hearing-impaired person must constantly pay attention to the actions of the referee, that person may not be able to play to his or her full potential.

### DISCLOSURE OF INVENTION

It is an object of the present invention to provide a whistle and a whistle signaling apparatus that enable a hearing-impaired person to be aware that the whistle has been blown, and to concentrate on playing without anxiety.

This object can be achieved by notifying a hearing-impaired person that a whistle has been blown by converting the sound of a whistle to the form of an indication that can be recognized visually.

### BRIEF DESCRIPTION OF DRAWINGS

FIG. 1 is a drawing showing the configuration of a whistle system according to Embodiment 1 of the present invention;

FIG. 2 is a block diagram showing the electrical configuration of a whistle of a whistle system according to Embodiment 1 of the present invention;

FIG. 3 is a block diagram showing the electrical configuration of a lamp apparatus of a whistle system according to Embodiment 1 of the present invention;

FIG. 4 is a drawing showing an example of the use of a whistle system according to Embodiment 1 of the present invention;

FIG. 5 is a block diagram showing a lamp apparatus of a whistle system according to Embodiment 2 of the present invention;

FIG. 6 is a drawing showing an example of the use of lamp apparatuses of a whistle system according to Embodiment 2 of the present invention;

FIG. 7 is a drawing showing the configuration of a whistle system according to Embodiment 3 of the present invention;

FIG. 8 is a drawing showing the configuration of a whistle system according to Embodiment 4 of the present invention;

FIG. 9 is a drawing showing an example of the use of lamp apparatuses of a whistle system according to Embodiment 4 of the present invention; and

FIG. 10 is a drawing showing an example of the use of a whistle system according to Embodiment 4 of the present invention.

### BEST MODE FOR CARRYING OUT THE INVENTION

With reference now to the accompanying drawings, embodiments of the present invention will be explained in detail below.

### Embodiment 1

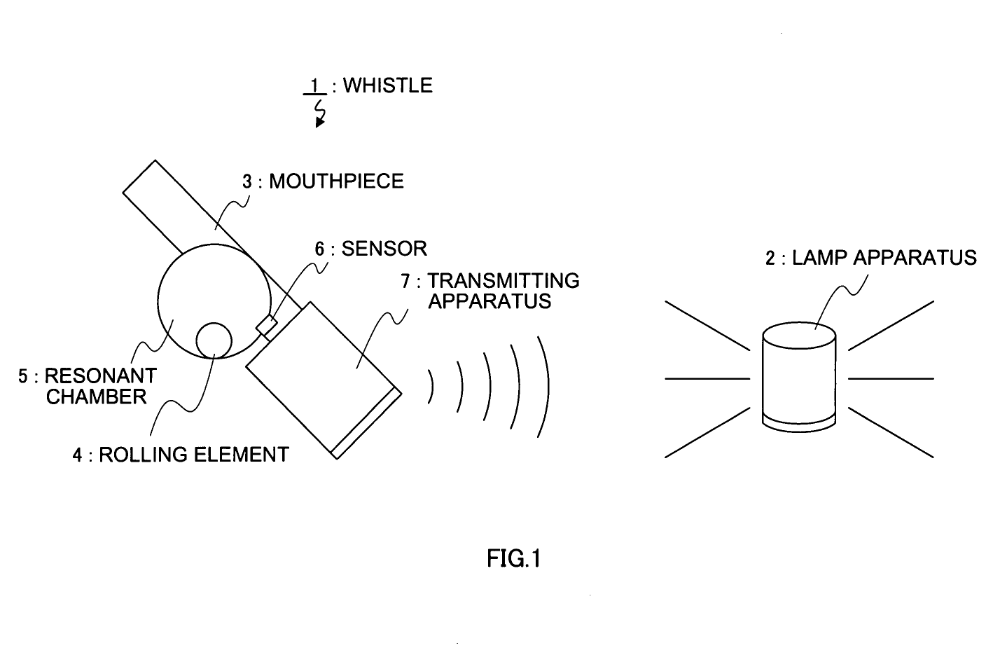

FIG. 1 is a drawing showing the configuration of a whistle system according to Embodiment 1 of the present invention.

In this drawing, a whistle system according to this embodiment is equipped with a whistle 1 and a lamp apparatus 2 that is a separate entity from whistle 1 and that receives whistle information transmitted by whistle 1 and gives an illuminated indication. Whistle 1 is equipped with a mouthpiece 3, a resonant chamber 5 containing a rolling element 4 made of cork or the like, a sensor 6 that detects movement of rolling element 4, and a transmitting apparatus 7 that transmits whistle information.

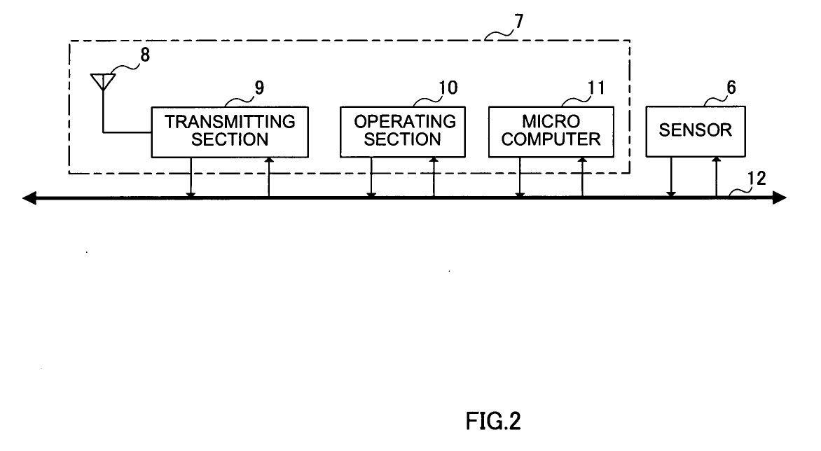

FIG. 2 is a block diagram showing the electrical configuration of whistle 1.

In this diagram, transmitting section 7 is equipped with an antenna 8, a transmitting section 9, an operating section 10, and a microcomputer 11. Each section of transmitting apparatus 7 and sensor 6 are connected via a bus line 12. Microcomputer 11 controls each section of transmitting apparatus 7, and therefore has a CPU, ROM that stores a program for operating the CPU, and RAM used in CPU operations (not shown). Operating section 10 is used to perform whistle 1 operations by means of a power supply on/off switch and so forth.

Transmitting section 9 transmits whistle information generated by microcomputer 11 based on sensor 6 output, using a carrier of a predetermined frequency. Sensor 6 detects vibration of rolling element 4 using a piezoelectric element, for example, and its output signal is taken in by microcomputer 11. Microcomputer 11 determines how the whistle was blown (strongly or weakly) based on the sensor 6 output signal level and variation of the output signal level over time, and generates whistle information to which the result of this determination is added. That is to say, when the whistle is blown strongly, whistle information is generated to which a determination result indicating that the whistle was blown strongly is added, and when the whistle is blown weakly, whistle information is generated to which a determination result indicating that the whistle was blown weakly is added. Whistle information generated by microcomputer 11 is input to transmitting section 9, and is transmitted by means of a carrier of a predetermined frequency.

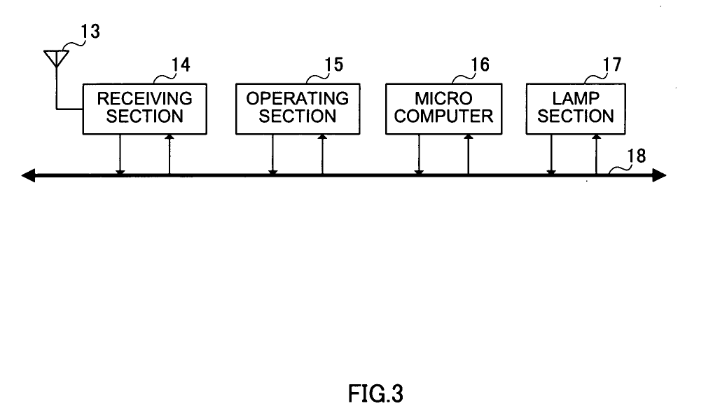

FIG. 3, on the other hand, is a block diagram showing the electrical configuration of lamp apparatus 2.

In this diagram, lamp apparatus 2 is equipped with an antenna 13, a receiving section 14 that demodulates whistle information from a radio signal captured by antenna 13 and outputs that information, an operating section 15 for operating this apparatus 2, a microcomputer 16 that controls each section of this apparatus 2, a lamp section 17 equipped with a lamp such as an incandescent lamp or a light emitting diode lamp, and a bus line 18 that interconnects receiving section 14, operating section 15, microcomputer 16, and lamp section 17.

Operating section 15 is used to perform apparatus 2 operations such as power supply on/off switch operations. As with above-described microcomputer 11 of whistle 1, microcomputer 16 has a CPU, ROM that stores a program for operating the CPU, and RAM used in CPU operations (not shown). Microcomputer 16 determines the intensity of the sound of a whistle from information to which whistle information has been added, obtained from receiving section 14, generates an illumination signal according to the result of that determination, and inputs this illumination signal to lamp section 17. Lamp section 17 illuminates the lamp in accordance with the illumination signal from microcomputer 16.

In this case, microcomputer 11 makes the interval at which the lamp is illuminated shorter when the whistle has been blown strongly, and makes the interval at which the lamp is illuminated longer when the whistle has been blown weakly. By this means, a player can visually recognize that the whistle has been blown, and also ascertain the intensity of the sound of the whistle.

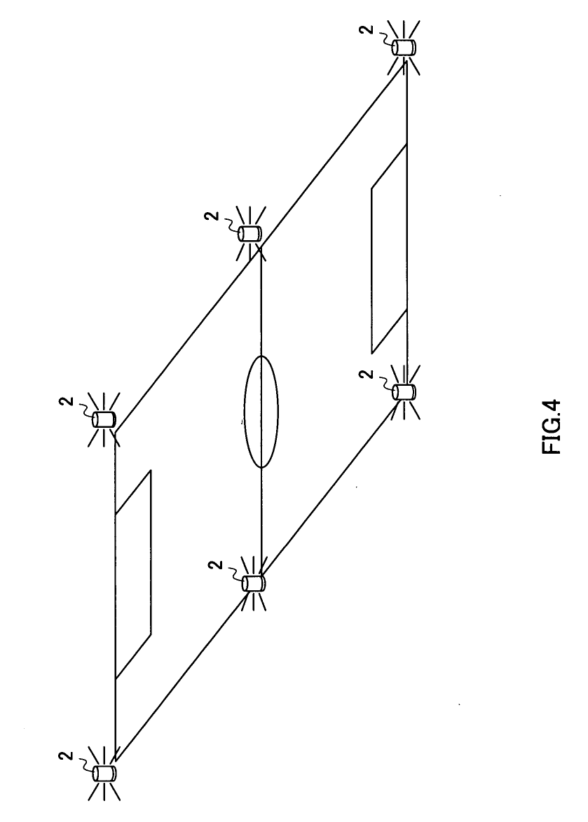

FIG. 4 shows an example of the use of lamp apparatuses 2 in soccer, in which it is assumed that lamp apparatuses 2 are placed on the surface of the ground. In a sport such as soccer that uses a large playing area, it is appropriate to use at least six lamp apparatuses 2 so that players can notice the flashing of lamp apparatuses 2 from any direction. In this example, a lamp apparatus 2 is placed at the left and right corners at each end of the pitch, and at each end of the halfway line.

Next, the operation of the above-described whistle system will be explained.

When air is blown into whistle 1, rolling element 4 rotates, and a whistle sound is generated. The vibration caused by the rotation of rolling element 4 is picked up by sensor 6, and a sensor signal is output. This sensor signal is input to microcomputer 11, the intensity of the whistle sound is determined according to the signal level at this time and variation of the signal level over time, and whistle information to which the result of this determination has been added is generated. The generated whistle information is then input to transmitting section 9, and is transmitted by means of a carrier of a predetermined frequency.

The radio signal transmitted from whistle 1 is transmitted by receiving section 14 of lamp apparatus 2, and the whistle information is demodulated. The demodulated whistle information is input to microcomputer 16, and the intensity of the sound of the whistle is determined. Then illumination control of lamp section 17 is performed in accordance with the whistle sound intensity determination result. That is to say, the lamp is illuminated at shorter intervals when the whistle has been blown strongly, and is illuminated at longer intervals when the whistle has been blown weakly.

Thus, according to a whistle system of this embodiment, whistle 1 generates and transmits whistle information when blown, and lamp apparatus 2 receives a radio signal transmitted from whistle 1, demodulates the whistle information, and illuminates a lamp in accordance with the intensity of the sound of the whistle based on the whistle information, thereby enabling the fact that the whistle has been blown, and the strength with which it has been blown, to be ascertained. By this means, when a hearing-impaired person takes part in a game, that person can avoid being involved in unnecessary play and can concentrate on playing without anxiety.

### Embodiment 2

FIG. 5 is a block diagram showing an external view of a lamp apparatus of a whistle system according to Embodiment 2 of the present invention.

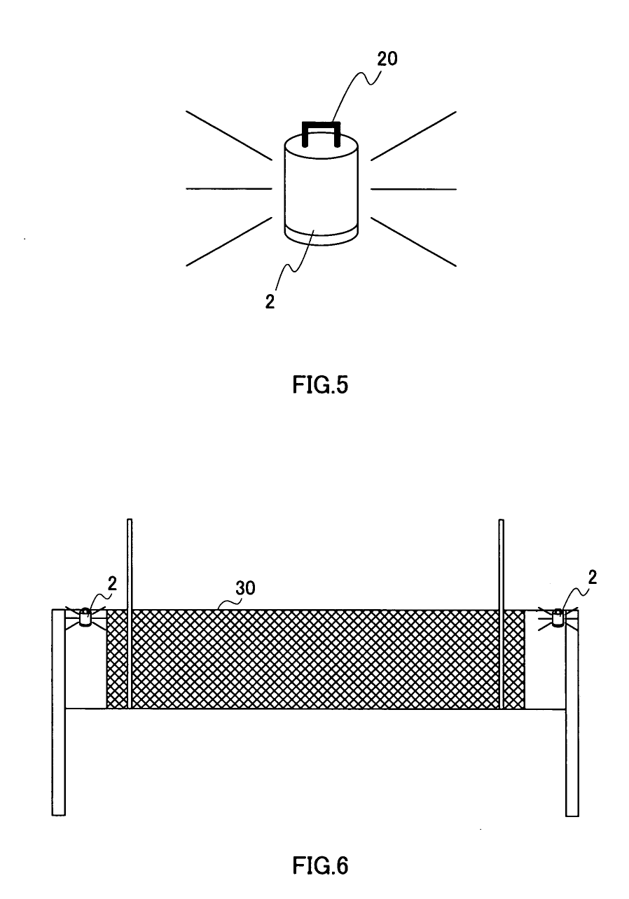

As shown in this drawing, in a whistle system according to this embodiment, a rack 20 is attached to lamp apparatus 2. Attaching rack 20 allows lamp apparatuses 2 to be hung on a net used in volleyball, tennis, badminton, table tennis, and so forth. FIG. 6 shows an example in which lamp apparatuses 2 are hung on the wire from which a volleyball net 30 is suspended. Suspending lamp apparatuses 2 enables the fact that a whistle has been blown to be ascertained without looking directly at the referee.

Thus, according to this embodiment, a rack 20 is attached to lamp apparatus 2, allowing lamp apparatus 2 to be suspended from a net or the like, thereby enabling the fact that a whistle has been blown to be ascertained while looking toward one's opponents.

In this embodiment, rack 20 is attached to the top of lamp apparatus 2, but rack 20 may also be attached to the side or the bottom. It is also possible to use a fastening device other than rack 20, such as a belt or hook-and-loop fastener.

### Embodiment 3

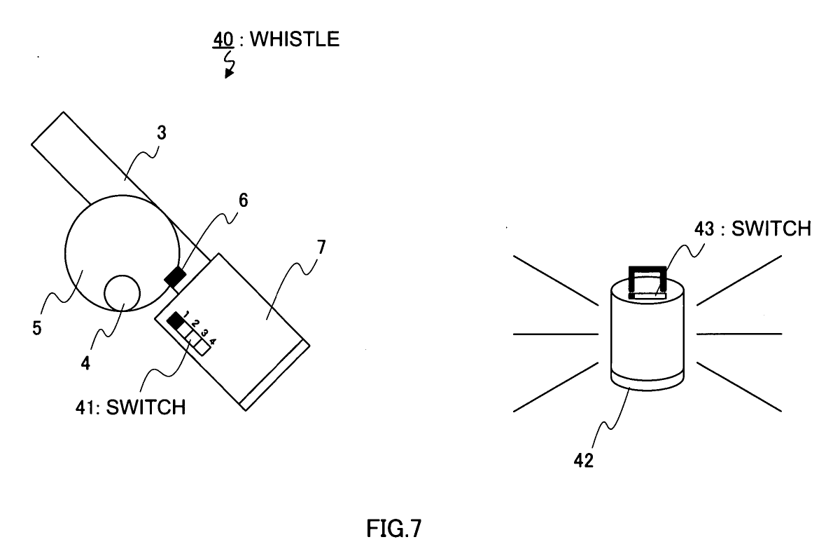

FIG. 7 is a drawing showing the configuration of a whistle system according to Embodiment 3 of the present invention.

A whistle system according to this embodiment has a function that enables the kind of whistle information that is to be transmitted to be set, making possible adjacent use of identical whistle systems. As it often happens in tournaments that matches are played on a number of adjacent courts, the blowing of a whistle might cause a lamp apparatus installed on an adjacent court to be illuminated. In a whistle system according to this embodiment, the kind of whistle information is coordinated between a whistle and a lamp apparatus constituting one set so that a lamp apparatus installed on an adjacent court will not be illuminated.

As shown in FIG. 7, a whistle 40 is equipped with a switch 41 that sets the kind of whistle information, and the kind of whistle information transmitted is changed by manipulating this switch 41. On the other hand, a lamp apparatus 42 is equipped with a switch 43 that selects the kind of whistle information to be received, and the kind of whistle information received is changed by manipulating this switch 43. Setting the same kind of whistle information between a whistle 40 and lamp apparatus 42 forming a pair prevents that lamp apparatus 42 from being operated by whistle information transmitted from a whistle 40 of another set.

Whistle 40 of this embodiment has a similar configuration to whistle 1 of Embodiment 1 shown in FIG. 2, but has switch 41 provided on operating section 10. Whistle 40 will now be described with reference to FIG. 2. When generating whistle information, microcomputer 11 of whistle 40 reads the set value of switch 41, and generates a kind of whistle information corresponding to that set value. In this case, the result of determination that determines the intensity of the sound of the whistle is added. The generated whistle information is input to transmitting section 9 and transmitted.

Lamp apparatus 42, on the other hand, has a similar configuration to lamp apparatus 2 of a whistle system according to Embodiment 1 shown in FIG. 3. Lamp apparatus 42 will now be described with reference to FIG. 3. When whistle information demodulated by receiving section 14 is input to microcomputer 16 of lamp apparatus 42, microcomputer 16 reads the set value of switch 43, determines whether or not the input whistle information matches the kind of whistle information corresponding to that set value, and discards that whistle information if the set value does not match, or performs lamp section 17 illumination control if the set value matches.

Thus, according to a whistle system of this embodiment, whistle 40 transmits whistle information of the kind set with switch 41, and lamp apparatus 42 compares received whistle information with the set value of switch 43, and illuminates the lamp only if they match, as a result of which identical whistle systems can be used next to each other in a normal manner without interference.

In this embodiment, interference between adjacent whistle systems is prevented by changing the kind of whistle information, but it is also possible to add unique identification information to whistle information, or to change the frequency.

### Embodiment 4

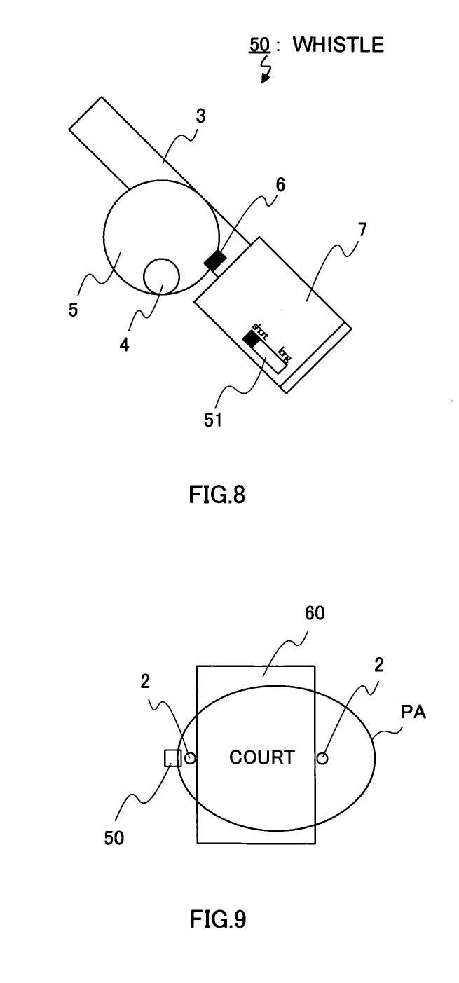

FIG. 8 is a drawing showing a whistle of a whistle system according to Embodiment 4 of the present invention.

In addition to the same functions as whistle 1 of Embodiment 1, a whistle of this embodiment has a function that enables transmission output to be adjusted.

As shown in this drawing, a whistle 50 of this embodiment is equipped with a sliding adjustor (such as a variable resistor, for example) 51, and when this adjustor 51 is manipulated, transmission output adjustment data corresponding to the amount of manipulation is input to microcomputer 11 (see FIG. 2) When microcomputer 11 takes in transmission output adjustment data, it performs transmitting section 9 gain adjustment so that the transmission output corresponds to that data. Specifically, gain adjustment is performed for a variable gain amplifier provided on the input side of the power amplifier comprising transmitting section 9.

Being able to adjust the transmission output in this way makes it possible to set transmission output appropriate to the size of the playing area. For example, a playing area not exceeding 30 m or so is used for volleyball, badminton, basketball, and the like, while sports such as soccer and rugby use the entire ground as a playing area. Setting the transmission output according to the size of the particular playing area enables unnecessary power consumption to be suppressed, and makes longer use possible as a result of the reduction in power consumption.

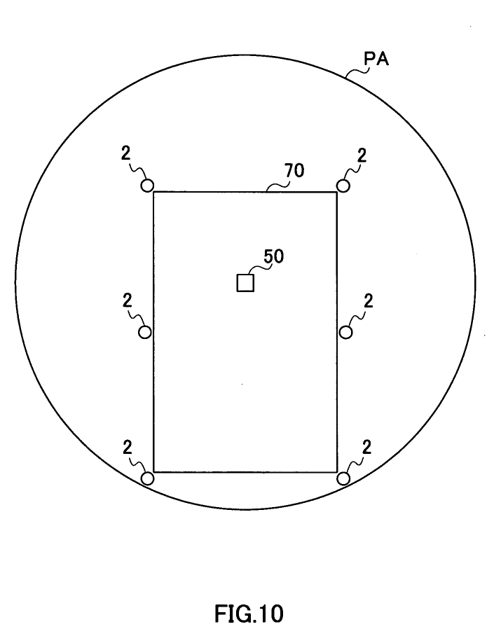

FIG. 9 is a drawing showing transmission output range PA in the case of use on a tennis court 60, and FIG. 10 is a drawing showing the transmission output range in the case of use on a soccer pitch 70. In the case of tennis court 60, when a lamp apparatus 2 is placed at either side of the center line, the transmission output is adjusted to a range that includes these two lamp apparatuses as shown in FIG. 9. In the case of soccer pitch 70, when a lamp apparatus 2 is placed at the left and right corners at each end of the pitch, and at each end of the halfway line, the transmission output is adjusted to a range that includes these lamp apparatuses as shown in FIG. 10.

Thus, according to a whistle system of this embodiment, a whistle 50 is provided that enables the transmission output to be adjusted, making it possible to set the transmission output according to the size of the playing area, and so enabling unnecessary power consumption to be suppressed, and making longer use possible as a result of the lower power consumption.

In the above-described embodiments, a piezoelectric element is used as sensor 6, but a photosensor or a photosensor and a light emitting device, for example, may also be used. In this case, if only a photosensor is used, the detecting surface of the sensor is positioned facing the airflow aperture of the body of the whistle. When the whistle is blown, rolling element 4 rotates, and the frequency with which rolling element 4 passes directly below the airflow aperture can be expected to vary according to the nature of this rotation. By obtaining statistics on this frequency, it is possible to determine the intensity of the sound of the whistle.

On the other hand, if a photosensor and a light emitting device are used, these are positioned opposite each other inside resonant chamber 5. When the whistle is blown, rolling element 4 rotates, and the frequency with which rolling element 4 passes between the photosensor and the light emitting device can be expected to vary according to the nature of this rotation. Thus, by obtaining statistics on this frequency, it is possible to determine the intensity of the sound of the whistle.

If the above-described embodiments are applied to a mobile terminal such as a mobile phone or PHS phone, owning such a mobile terminal will enable play to be enjoyed anywhere and anytime.

As described above, according to the present invention a whistle can be provided that enables a hearing-impaired person to be aware that a whistle has been blown, and to concentrate on playing without anxiety.

This application is based on Japanese Patent Application No. 2003-11998 filed on Jan. 21, 2003, the entire content of which is expressly incorporated by reference herein.

### INDUSTRIAL APPLICABILITY

The present invention is suitable for use in a whistle used as a signal in sports and so forth, and a whistle signaling apparatus.

1. A whistle comprising:
a whistle body;
a rolling element contained in a resonant chamber of said whistle body;
a detection section that detects movement of said rolling element;
a whistle information generation section that generates whistle information when movement of said rolling element is detected by said detection section; and
a transmitting section that transmits whistle information generated by said whistle information generation section.

2. The whistle according to claim 1, further comprising a selection section that selects one of a plurality of kinds of whistle information;
wherein said whistle information generation section generates a kind of whistle information selected by said selection section when generating whistle information.

3. The whistle according to claim 1, wherein:
said detection section outputs a signal of a level in accordance with a magnitude of movement of said rolling element; and
said whistle information generation section determines a manner of whistle blowing based on a detection signal level of said detection section and variation of said detection signal level over time, and generates whistle information including a result of that determination.

4. The whistle according to claim 1, further comprising a transmission output adjustment section that adjusts transmission output of said transmitting section.

5. A mobile terminal equipped with a whistle, wherein said whistle comprises:
a whistle body;
a rolling element contained in a resonant chamber of said whistle body;
a detection section that detects movement of said rolling element;
a whistle information generation section that generates whistle information when movement of said rolling element is detected by said detection section; and
a transmitting section that transmits whistle information generated by said whistle information generation section.

6. A whistle signaling apparatus comprising:
a receiving section that receives a radio signal and demodulates whistle information;
an illumination section; and
a control section that performs illumination control of said illumination section when whistle information is demodulated by said receiving section.

7. The whistle signaling apparatus according to claim 6, further comprising a selection section that selects one of a plurality of kinds of whistle information;
wherein said control section, when whistle information is demodulated by said receiving section, determines whether or not demodulated whistle information matches whistle information selected by said selection section, and performs illumination control of said illumination section only if demodulated whistle information matches whistle information selected by said selection section.

8. The whistle signaling apparatus according to claim 6, further comprising an installation member enabling installation on a predetermined item.

9. A mobile terminal equipped with a whistle signaling apparatus, wherein said whistle signaling apparatus comprises:
a receiving section that receives a radio signal and demodulates whistle information;
an illumination section; and
a control section that performs illumination control of said illumination section when whistle information is demodulated by said receiving section.

10. A whistle system equipped with a whistle and a whistle signaling apparatus, wherein:
said whistle comprises:
a whistle body;
a rolling element contained in a resonant chamber of said whistle body;
a detection section that detects movement of said rolling element;
a whistle information generation section that generates whistle information when movement of said rolling element is detected by said detection section; and
a transmitting section that transmits whistle information generated by said whistle information generation section; and
said whistle signaling apparatus comprises:
a receiving section that receives a radio signal and demodulates whistle information;
an illumination section; and
a control section that performs illumination control of said illumination section when whistle information is demodulated by said receiving section.
